(19) United States
(12) Patent Application Publication
(10) Pub. No.: US 2011/0122042 A1
(43) Pub. Date: May 26, 2011

(54) Antenna with Multi-Bands

(75) Inventors: Chih-Yung Huang, Dongshih Township (TW); Kuo-Chang Lo, Hsinchu (TW)

(73) Assignee: Arcadyan Technology Corporation

(21) Appl. No.: 12/904,426

(22) Filed: Oct. 14, 2010

(30) Foreign Application Priority Data
Nov. 20, 2009 (TW) 098139644

(51) Int. Cl. H01Q 9/04; H01Q 1/50

(52) U.S. Cl. 343/860; 343/700 MS

(57) ABSTRACT

An antenna connected to an interface connection port is provided. The antenna comprises a ground surface having a plurality of bands thereon; a first radiation element disposed on the ground surface and including a first bending section and a second bending section, wherein the ground surface is extended from the first bending section; and a second radiation element having a shape of a strip, extended from the second bending section, including a first end and a second end, and having a first flange at the first end and a second flange at the second end.

### FIELD OF THE INVENTION

The present invention relates to an antenna, and more particularly to an antenna with multi-bands.

### BACKGROUND OF THE INVENTION

The antenna is a transducer for transmitting or receiving the electromagnetic wave. In other words, the antenna will convert the electromagnetic wave into the current.

Since the microstrip antenna has a small size (about 0.01-0.05 free-space wavelength), compared with other types of antennas, it is most suitable for the micro-electro-mechanical process. Besides, the microstrip antenna also has a light weight and a thin thickness, and the production cost thereof is low. Due to the above advantages, the microstrip antenna is widely applied to the military and space industries.

The PIFA (planar inverse-F antenna) is a kind of microstrip antenna. FIG. 1 shows a conventional PIFA. The PIFA 1 includes a main oscillation body 11 (the length thereof is about ¼λ), a circular F-shaped head 12, a feed line 13, a first hole 14 and a second hole 15, wherein the top of the circular F-shaped head 12 is grounded.

Unfortunately, the bandwidth and bandwidth percentage of the PIFA 1 are both poor. This limits the applicable ranges of the PIFA 1.

In order to overcome the drawbacks in the prior art, an antenna with multi-bands is provided. The particular design in the present invention not only solves the problems described above, but also is easy to be implemented. Thus, the present invention has the utility for the industry.

### SUMMARY OF THE INVENTION

In accordance with another aspect of the present invention, an antenna connected to an interface connection port is provided. The antenna comprises a ground surface having a plurality of bands thereon; a first radiation element disposed on the ground surface and including a first bending section and a second bending section, wherein the ground surface is extended from the first bending section; and a second radiation element having a shape of a strip, extended from the second bending section, including a first end and a second end, and having a first flange at the first end and a second flange at the second end.

Preferably, the second bending section further has a feed point electrically connected to a signal source.

Preferably, the feed point is near the ground surface.

Preferably, the second radiation element is approximately parallel to the ground surface.

Preferably, the first bending section and the second bending section both include at least a bending angle.

Preferably, the bending angle is 90 degrees.

Preferably, the plurality of bands are adjusted according to a distance between the antenna and the interface connection port.

Preferably, the antenna has an operating frequency adjusted by an area between the second bending section and the first flange.

Preferably, the first flange has an area larger than that of the second flange.

Preferably, the antenna has an impedance matching coarsely adjusted by the first flange and finely adjusted by the second flange.

Preferably, the antenna performs at least one of actions of receiving and transmitting a wireless signal having a band of substantially 330 MHz.

Preferably, the first bending section and the ground surface form an area for adjusting an impedance matching of the antenna.

In accordance with another aspect of the present invention, an antenna connected to an interface connection port is provided. The antenna comprises a ground surface having a plurality of bands thereon; a first radiation element disposed on the ground surface and including at least two bending sections, wherein each of the bending sections includes at least a bending angle; a feed point positioned in one of the bending sections and electrically connected to a signal source; and a second radiation element having a shape of a strip, extended from the first radiation element, including a first end and a second end, and having a first flange at the first end and a second flange at the second end.

Preferably, the bending angle is 90 degrees.

Preferably, the plurality of bands are adjusted according to a distance between the antenna and the interface connection port.

Preferably, the feed point is near the ground surface.

Preferably, the second radiation element is approximately parallel to the ground surface.

Preferably, the antenna has an impedance matching coarsely adjusted by the first flange.

Preferably, the antenna has an impedance matching finely adjusted by the second flange.

Preferably, the antenna performs at least one of actions of receiving and transmitting a wireless signal having a band of substantially 330 MHz.

Preferably, the bending sections and the ground surface form an area for adjusting an impedance matching of the antenna.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a conventional PIFA;

FIG. 2(a) shows the antenna with multi-bands according to a preferred embodiment of the present invention;

FIG. 2(b) shows the antenna with multi-bands according to a preferred embodiment of the present invention;

FIG. 3 shows a current path generated by inputting a signal source to a feed point of the first radiation element;

FIG. 4(a) shows the method of fixing the antenna in a mechanical way;

FIG. 4(b) shows the method of fixing the antenna in a binding way;

FIG. 5 shows the adjustable bandwidths under different bands on the ground surface;

FIG. 6 shows that VSWR drops below the desirable maximum value “2” in the band 2.29 GHz to 2.59 GHz which is indicating a bandwidth of 300 MHz, which fully covers the bandwidths of wireless communications of WiFi band standards;

FIG. 7 shows that return loss drops below the desirable maximum value −10 dB in the band 2.29 GHz to 2.59 GHz which is indicating a bandwidth of 300 MHz, which fully covers the bandwidths of wireless communications of WiFi band standards;

FIG. 8(a) shows the radiation pattern of the antenna operating at the frequency of 2.4 GHz in the Y-Z plane;

FIG. 8(b) shows the radiation pattern of the antenna operating at the frequency of 2.45 GHz in the Y-Z plane;

FIG. 8(c) shows the radiation pattern of the antenna operating at the frequency of 2.5 GHz in the Y-Z plane;

FIG. 9(a) shows the radiation pattern of the antenna operating at the frequency of 2.4 GHz in the Z-X plane;

FIG. 9(b) shows the radiation pattern of the antenna operating at the frequency of 2.45 GHz in the Z-X plane;

FIG. 9(c) shows the radiation pattern of the antenna operating at the frequency of 2.5 GHz in the Z-X plane;

FIG. 10(a) shows the radiation pattern of the antenna operating at the frequency of 2.4 GHz in the X-Y plane;

FIG. 10(b) shows the radiation pattern of the antenna operating at the frequency of 2.45 GHz in the X-Y plane; and

FIG. 10(c) shows the radiation pattern of the antenna operating at the frequency of 2.5 GHz in the X-Y plane.

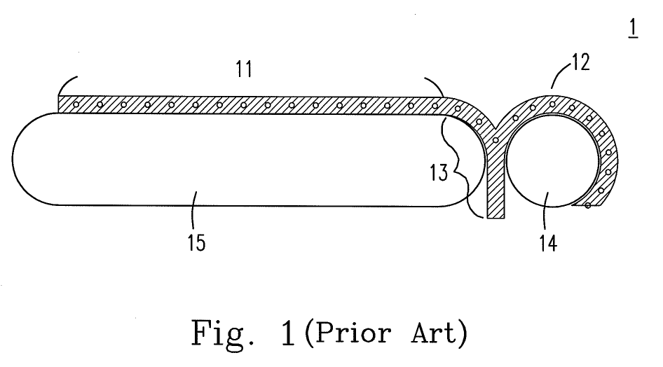

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

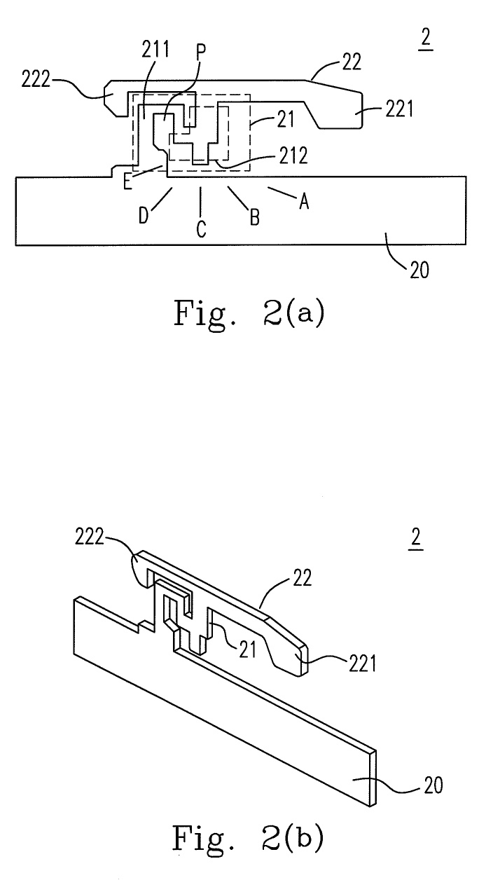

Please refer to FIGS. 2(a) and 2(b), which show the antenna with multi-bands 2 according to a preferred embodiment of the present invention. The antenna with multi-bands 2 includes a ground surface 20, a first radiation element 21 and a second radiation element 22. The ground surface 20 is electrically connected to the ground. The first radiation element 21 is disposed on the ground surface 20, and includes a first bending section 211 and a second bending section 212. That is, the first radiation element 21 has a plurality of bending sections 211, 212. As shown in FIG. 2(a), the first bending section 211 and the second bending section 212 both include at least a bending angle. In this embodiment, each bending angle is 90 degrees. The second radiation element 22 has a shape of a strip, and is extended from the second bending section 212. The second radiation element 22 includes a first end and a second end, and has a first flange 221 at the first end and a second flange 222 at the second end. Preferably, the area of the first flange 221 is larger than that of the second flange 222. The second radiation element 22 is approximately parallel to the ground surface.

The area between the second bending section 212 and the first flange 212 is used for adjusting the operating frequency of the antenna with multi-bands 2. The first flange 221 is used for coarsely adjusting the impedance matching of the antenna with multi-bands 2, and the second flange 222 is used for finely adjusting the impedance matching of the antenna with multi-bands 2. The first bending section 211 and the ground surface 20 form an area P for adjusting the impedance matching of the antenna with multi-bands 2.

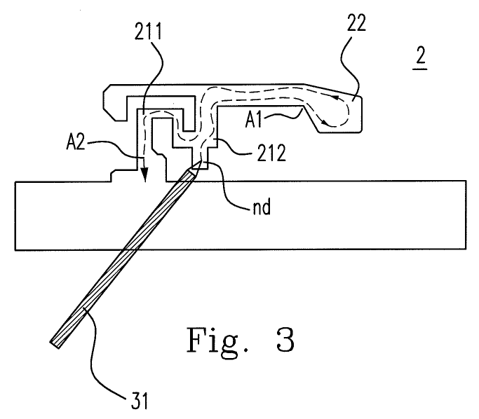

Please refer to FIG. 3, which shows a current path A1 generated by inputting a signal source 31 to a feed point nd of the first radiation element 21. In this embodiment, the signal source 31 is a cable. The feed point nd is positioned in the second bending section 212 and near the ground surface 20.

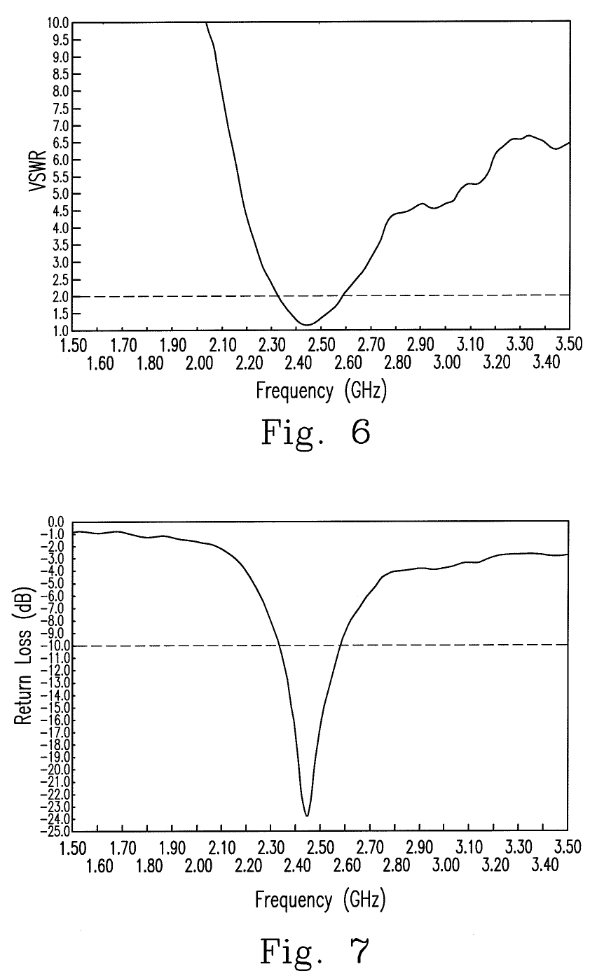

In the current path A1, the current flows along the second bending section 212 of the first radiation element 21 to the second radiation element 22. Subsequently, the current flows back to the second bending section 212 and the first bending section 211 of the first radiation element 21 due to reflection. At this time, the current path A1 is changed to another current path A2. In the current path A2, since the current flows through a plurality of bending angles of the first bending section 211 and the second bending section 212 (each bending angle is 90 degrees), the reflection current of the current path A2 is reduced. This reduces the voltage standing wave ratio (VSWR) of the antenna with multi-bands 2. Please refer to FIG. 6, which shows that VSWR drops below the desirable maximum value “2” in the band 2.29 GHz to 2.59 GHz which is indicating a bandwidth of 300 MHz, which fully covers the bandwidths of wireless communications of WiFi band standards.

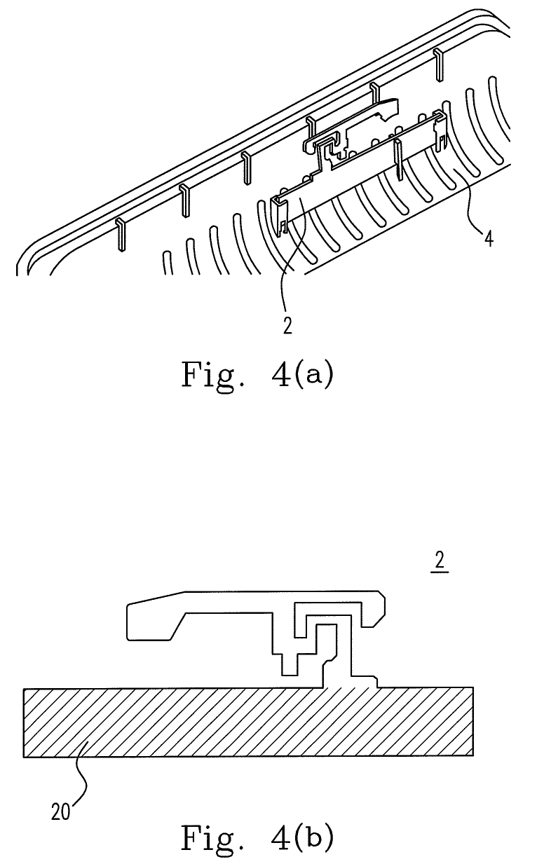

There are two ways to fix the antenna with multi-bands 2 to an interface connection port 4 of an electronic device (not shown), such as a notebook computer or a cellphone. One way is to fix the antenna with multi-bands 2 to the interface connection port 4 in a mechanical way, which can be adjusted according to different systems, as shown in FIG. 4(a). The other way is to fix the antenna with multi-bands 2 to the interface connection port 4 in a binding way, i.e. binding the back (represented by the oblique line) of the ground surface 20 of the antenna with multi-bands 2 to the interface connection port 4 with glue.

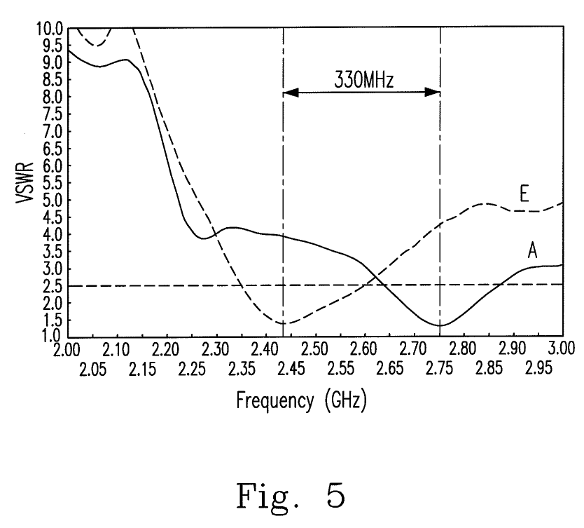

Please refer to FIG. 2(a) again. As shown in FIG. 2(a), the ground surface 20 has five bands A, B, C, D, E. The five bands A, B, C, D, E can be adjusted according to the distance between the antenna with multi-bands 2 and the interface connection port 4 so as to modify the respective frequency responses thereof to the applicable bands. The adjustable bandwidth is 330 MHz, as shown in FIG. 5. In FIG. 5, the band E is represented by the dotted line and the band A is represented by the solid line.

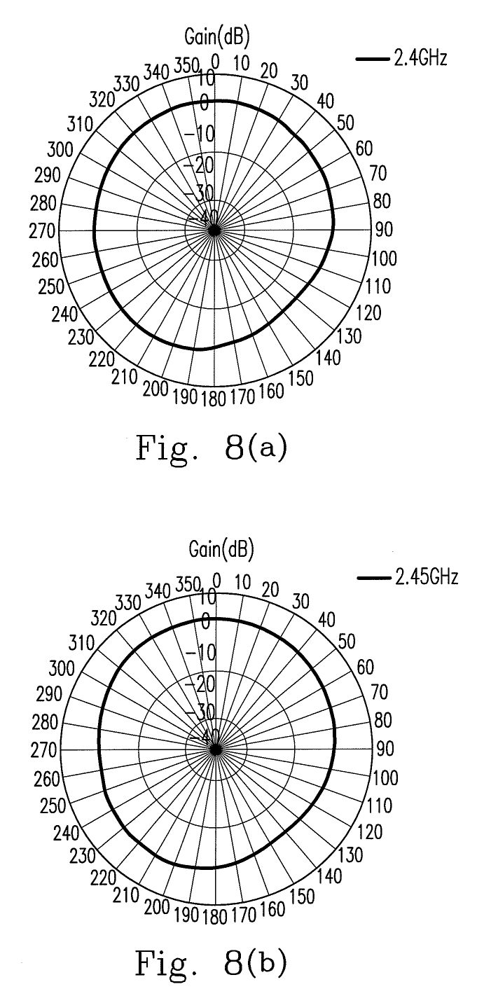

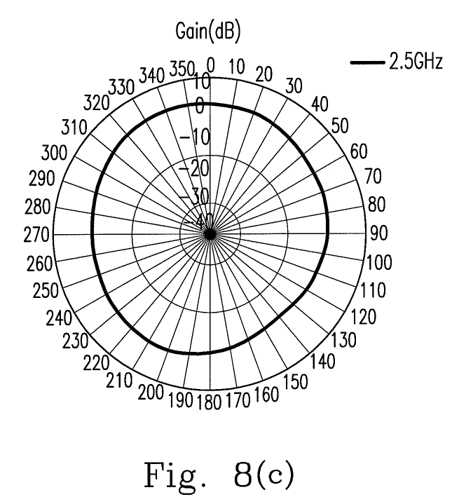

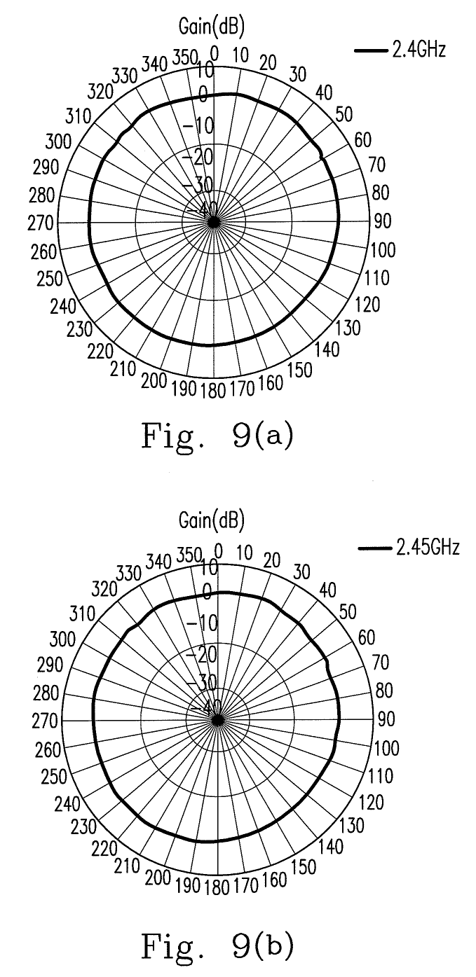

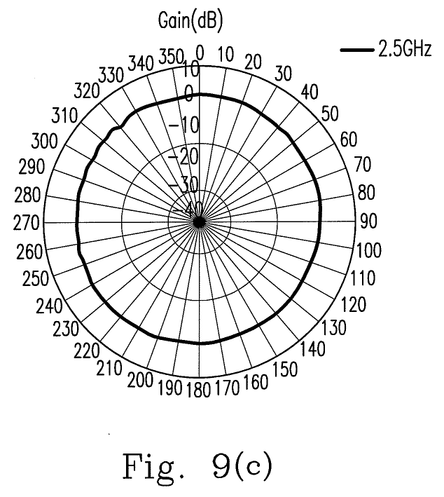

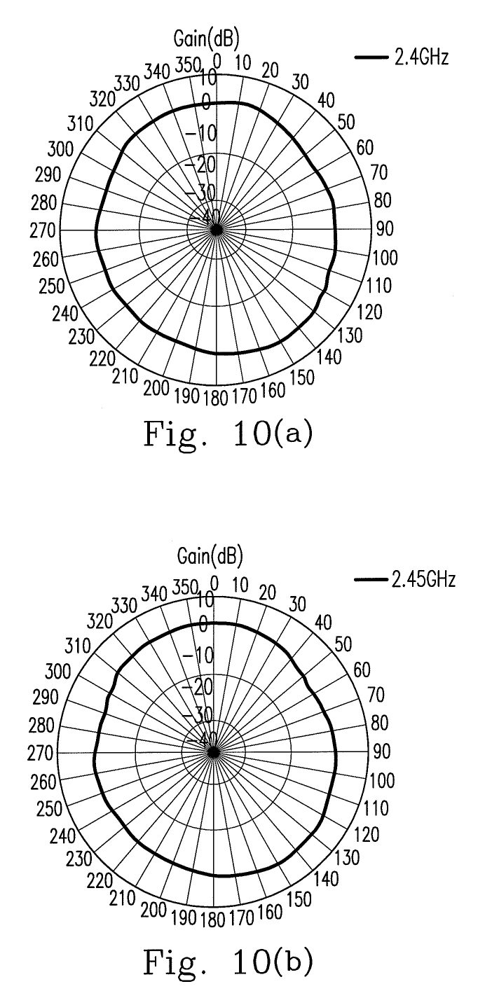

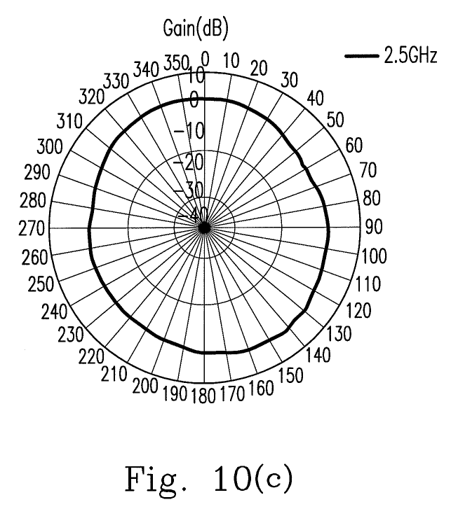

Moreover, other radiation characteristics of the antenna with multi-bands 2 can be obtained through experiment and measurement. Please refer to FIGS. 7, 8(a)-8(c), 9(a)-9(c) and 10(a)-10(c). FIG. 7 shows that return loss drops below the desirable maximum value −10 dB in the band 2.29 GHz to 2.59 GHz which is indicating a bandwidth of 300 MHz, which fully covers the bandwidths of wireless communications of WiFi band standards. FIG. 8(a) shows the radiation pattern of the antenna operating at the frequency of 2.4 GHz in the Y-Z plane. FIG. 8(b) shows the radiation pattern of the antenna operating at the frequency of 2.45 GHz in the Y-Z plane. FIG. 8(c) shows the radiation pattern of the antenna operating at the frequency of 2.5 GHz in the Y-Z plane. FIG. 9(a) shows the radiation pattern of the antenna operating at the frequency of 2.4 GHz in the Z-X plane. FIG. 9(b) shows the radiation pattern of the antenna operating at the frequency of 2.45 GHz in the Z-X plane. FIG. 9(c) shows the radiation pattern of the antenna operating at the frequency of 2.5 GHz in the Z-X plane. FIG. 10(a) shows the radiation pattern of the antenna operating at the frequency of 2.4 GHz in the X-Y plane. FIG. 10(b) shows the radiation pattern of the antenna operating at the frequency of 2.45 GHz in the X-Y plane. FIG. 10(c) shows the radiation pattern of the antenna operating at the frequency of 2.5 GHz in the X-Y plane. Table 1 shows the peak and average gains of the antenna with multi-bands 2 in the Y-Z, Z-X and X-Y planes respectively.

TABLE 1

| Preferred embodiment of the | | | | |
|---|---|---|---|---|
| present invention | | WiFi antenna | | |
| | Band | WiFi (11 b/g) | | |
| Setup | Frequency (GHz) | 2.4 GHz | 2.45 GHz | 2.5 GHz |
| Y-Z plane | Peak gain (dBi) | 1.43 | 1.86 | 1.70 |
| | Avg. gain (dBi) | −0.96 | −0.78 | −0.90 |
| Z-X plane | Peak gain (dBi) | 1.39 | 0.89 | 0.83 |
| | Avg. gain (dBi) | 0.16 | −0.34 | −0.44 |
| X-Y plane | Peak gain (dBi) | 1.53 | 1.71 | 1.88 |
| | Avg. gain (dBi) | −0.44 | −0.30 | −0.19 |

The definitions and detailed measuring methods for the radiation characteristics of the antenna with multi-bands 2 are well-known to the skilled person, so they are not described here.

In conclusion, the present invention reduces the VSWR through the first bending section 211 and the second bending section 212 of the first radiation element 21 to enable the antenna with multi-bands 2 to achieve the broadband or multi-band effect. Besides, the bending direction and the number of bending of the first and the second bending sections 211, 212 can be adjusted according to actual needs. Therefore, the antenna with multi-bands 2 of the present invention not only can easily achieve the broadband or multi-band effect but also has a simple and firm structure. Moreover, the present invention can efficiently reduce the production cost as well. Hence, the present invention effectively solves the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An antenna connected to an interface connection port, comprising:
a ground surface having a plurality of bands thereon;
a first radiation element disposed on the ground surface and including a first bending section and a second bending section, wherein the ground surface is extended from the first bending section; and
a second radiation element having a shape of a strip, extended from the second bending section, including a first end and a second end, and having a first flange at the first end and a second flange at the second end.

2. An antenna as claimed in claim 1, wherein the second bending section further has a feed point electrically connected to a signal source.

3. An antenna as claimed in claim 2, wherein the feed point is near the ground surface.

4. An antenna as claimed in claim 1, wherein the second radiation element is approximately parallel to the ground surface.

5. An antenna as claimed in claim 1, wherein the first bending section and the second bending section both include at least a bending angle.

6. An antenna as claimed in claim 5, wherein the bending angle is 90 degrees.

7. An antenna as claimed in claim 1, wherein the plurality of bands are adjusted according to a distance between the antenna and the interface connection port.

8. An antenna as claimed in claim 1, wherein the antenna has an operating frequency adjusted by an area between the second bending section and the first flange.

9. An antenna as claimed in claim 1, wherein the first flange has an area larger than that of the second flange.

10. An antenna as claimed in claim 9, wherein the antenna has an impedance matching coarsely adjusted by the first flange and finely adjusted by the second flange.

11. An antenna as claimed in claim 1, wherein the antenna performs at least one of actions of receiving and transmitting a wireless signal having a band of substantially 330 MHz.

12. An antenna as claimed in claim 1, wherein the first bending section and the ground surface form an area for adjusting an impedance matching of the antenna.

13. An antenna connected to an interface connection port, comprising:
a ground surface having a plurality of bands thereon;
a first radiation element disposed on the ground surface and including at least two bending sections, wherein each of the bending sections includes at least a bending angle;
a feed point positioned in one of the bending sections and electrically connected to a signal source; and
a second radiation element having a shape of a strip, extended from the first radiation element, including a first end and a second end, and having a first flange at the first end and a second flange at the second end.

14. An antenna as claimed in claim 13, wherein the bending angle is 90 degrees.

15. An antenna as claimed in claim 13, wherein the plurality of bands are adjusted according to a distance between the antenna and the interface connection port.

16. An antenna as claimed in claim 13, wherein the feed point is near the ground surface.

17. An antenna as claimed in claim 13, wherein the second radiation element is approximately parallel to the ground surface.

18. An antenna as claimed in claim 13, wherein the antenna has an impedance matching coarsely adjusted by the first flange.

19. An antenna as claimed in claim 13, wherein the antenna has an impedance matching finely adjusted by the second flange.

20. An antenna as claimed in claim 13, wherein the antenna performs at least one of actions of receiving and transmitting a wireless signal having a band of substantially 330 MHz.

21. An antenna as claimed in claim 13, wherein the bending sections and the ground surface form an area for adjusting an impedance matching of the antenna.
